(19) United States
(12) Patent Application Publication
(10) Pub. No.: US 2020/0293613 A1
(43) Pub. Date: Sep. 17, 2020

(54) METHOD AND SYSTEM FOR IDENTIFYING AND RENDERING HAND WRITTEN CONTENT ONTO DIGITAL DISPLAY INTERFACE

(71) Applicant: Wipro Limited, Bangalore (IN)

(72) Inventor: Manjunath Ramachandra Iyer, Bangalore (IN)

(21) Appl. No.: 16/359,063

(22) Filed: Mar. 20, 2019

(30) Foreign Application Priority Data
Mar. 12, 2019 (IN) 201941009514

(51) Int. Cl. G06F 17/24; G06F 3/0354

(52) U.S. Cl. CPC G06F 17/243; G06F 3/03545

(57) ABSTRACT

The present disclosure discloses method and a content providing system for identifying and rendering hand written content onto digital display interface of electronic device. The content providing system receives content handwritten by user using digital pointing device and identifies one or more digital objects from content based on coordinate vector formed between digital pointing device and boundary within which user writes along with coordinates of boundary. The content providing system converts one or more digital objects to predefined standard size and identifies one or more characters associated with one or more digital objects based on plurality of predefined character pair and corresponding coordinates. A dimension space required for each of digital objects is determined based on corresponding coordinate vector. Thereafter, the one or more digital objects and the one or more characters handwritten by the user are rendered in predefined standard format on digital display interface.

### TECHNICAL FIELD

The present subject matter is related in general to content rendering and digital pen-based computing, more particularly, but not exclusively to a method and system for identifying and rendering hand written content onto digital display interface of an electronic device.

### BACKGROUND

With advancement in Information Technology (IT), usage of digital devices has increased substantially in recent years across all age groups. With an increase in the digital devices, people generate lots of digital content for seamless exchange in real time and archival. Typically, while generating any content, components such as, text, tables, figures, graphs and the like play a significant role in the content. While there are many software tools available to ingest such variants individually, it is more comfortable for a user to write fast with freehand sketches, tables or graphs on a paper rather than looking for the right application and type or use a mouse/joystick to ingest the content.

In order to support such requirement, existing systems enable the user to hold a stylus or any pointing devices to write on a paper or any smooth surface. In such case, virtual handwritten characters are translated to one of standard fonts which a machine can understand and interpret. While existing technologies stand at this point, there exist significant hurdles for comfortable use. Particularly, in the pointing devices, there is a lack of mechanism to distinguish figures, OCR, tables, drawings and the like and everything is treated as a figure. Also, it is required that the existing systems know a priori what the user is trying to write is the text, the figure or table and the like. Further, existing systems may lack in providing a mechanism to map three-dimensional and four-dimensional objects through the pointing devices. Additionally, tracing, scanning and presenting subsequent views of three-dimensional and four-dimensional objects pose a problem in such space.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure may relate to a method for identifying and rendering hand written content onto digital display interface of an electronic device. The method includes receiving content handwritten by a user in real-time using a digital pointing device. From the content, one or more digital objects is identified based on coordinate vector formed between the digital pointing device and a boundary within which the user writes along with coordinates of the boundary using a trained neural network. The method includes converting the one or more digital objects to a predefined standard size and identifying one or more characters associated with the one or more digital objects based on a plurality of predefined character pair and corresponding coordinates. Further, a dimension space required for each of the one or more digital objects is determined based on corresponding coordinate vector to render on the digital display interface. Each of the one or more digital objects are converted to the determined dimension space. Thereafter, the method includes rendering the one or more digital objects and the one or more characters handwritten by the user in a predefined standard format on the digital display interface.

In an embodiment, the present disclosure may relate to a content providing system for identifying and rendering hand written content onto digital display interface of an electronic device. The content providing system may include a processor and a memory communicatively coupled to the processor, where the memory stores processor executable instructions, which, on execution, may cause the content providing system to receive content handwritten by a user in real-time using a digital pointing device. From the content, one or more digital objects is identified based on coordinate vector formed between the digital pointing device and a boundary within which the user writes along with coordinates of the boundary using a trained neural network. The content providing system converts the one or more digital objects to a predefined standard size and identifies one or more characters associated with the one or more digital objects based on a plurality of predefined character pair and corresponding coordinates. Further, the content providing system determines a dimension space required for each of the one or more digital objects based on corresponding coordinate vector to render on the digital display interface. Each of the one or more digital objects are converted to the determined dimension space. Thereafter, the content providing system renders the one or more digital objects and the one or more characters handwritten by the user in a predefined standard format on the digital display interface.

In an embodiment, the present disclosure relates to a non-transitory computer readable medium including instructions stored thereon that when processed by at least one processor may cause a content providing system to receive content handwritten by a user in real-time using a digital pointing device. From the content, one or more digital objects is identified based on coordinate vector formed between the digital pointing device and a boundary within which the user writes along with coordinates of the boundary using a trained neural network. The instruction causes the processor to convert the one or more digital objects to a predefined standard size and identifies one or more characters associated with the one or more digital objects based on a plurality of predefined character pair and corresponding coordinates. Further, the instruction causes the processor to determine a dimension space required for each of the one or more digital objects based on corresponding coordinate vector to render on the digital display interface. Each of the one or more digital objects are converted to the determined dimension space. Thereafter, the instruction causes the processor to render the one or more digital objects and the one or more characters handwritten by the user in a predefined standard format on the digital display interface.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for identifying and rendering hand written content onto digital display interface of an electronic device in accordance with some embodiments of the present disclosure;

FIG. 2a shows a detailed block diagram of a content providing system in accordance with some embodiments of the present disclosure;

FIG. 2b shows an exemplary representation of a standard contour library of alphabets in accordance with some embodiments of the present disclosure;

FIG. 2c shows an exemplary Convolutional Neural Network (CNN) for segregating type of digital objects;

FIG. 2d shows an exemplary representation of converting one or more digital objects to predefined standard in accordance with some embodiments of the present disclosure;

FIG. 2e shows an exemplary representation for identification of characters using neural networks in accordance with some embodiments of the present disclosure;

FIG. 2f shows an exemplary representation of images of two consecutive alphabets letters in accordance with embodiments of the present disclosure;

FIG. 2g shows an exemplary representation of scaling characters in accordance with some embodiments of the present disclosure;

FIG. 3 illustrates a flowchart showing a method for identifying and rendering hand written content onto digital display interface of an electronic device in accordance with some embodiments of present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure relate to a method and a content providing system for identifying and rendering hand written content onto digital display interface of an electronic device. In an embodiment, the electronic device may be associated with a user. Particularly, in order to provide any information most users find freehand writing to be most ease and comfortable. Typically, the users may use pointing devices for writing content such that the written content are translated to one or more standard format. Though, such systems provide freehand mechanism to the users, the systems may lack to distinguish objects such as, figures, OCR, tables, drawings and the like from the content. The present disclosure in such case may identify one or more digital objects from content handwritten by a user using a digital pointing device by a trained neural network. The one or more digital objects may be text, table, graph, figure and the like. Characters associated with the one or more digital objects may be determined based on a plurality of predefined character pairs. Dimension space required for each of the one or more digital objects is determined based on corresponding coordinate vector such that each of the one or more digital objects are converted to respective determined dimension space. Thereafter, the one or more digital objects along with characters handwritten by the user may be rendered in a predefined standard format on the digital display interface. The present disclosure accurately differentiate between figures, tables, characters and graphs hand written/gestured by the user for rendering on the electronic device.

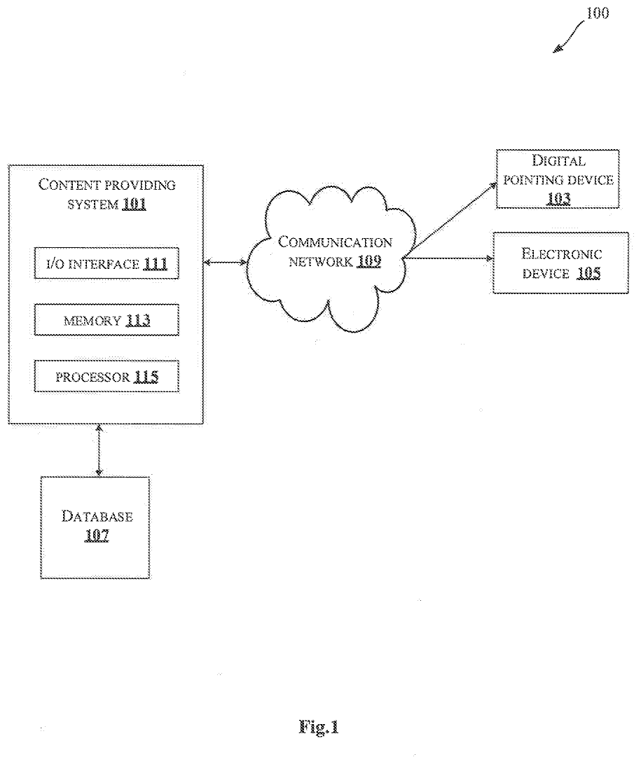

FIG. 1 illustrates an exemplary environment for identifying and rendering hand written content onto digital display interface of an electronic device in accordance with some embodiments of the present disclosure.

As shown in FIG. 1, an environment 100 includes a content providing system 101 connected through a communication network 109 to a digital pointing device 103 and an electronic device 105 associated with a user. A person skilled in the art would understand that the content providing system 101 may be connected to a plurality of digital pointing devices and electronic devices associated with users (not shown explicitly in the FIG. 1). Further, the content providing system 101 may also be connected to a database 107. In an embodiment, the digital pointing device 103 may refer to an input device which may capture handwriting or brush strokes of a user and converts handwritten information into digital content. The digital pointing device 103 may include digital pen, stylus and the like. A person skilled in the art would understand that any other digital pointing device 103 not mentioned herein explicitly may also be used in the present disclosure. The electronic device 105 may be associated with users who may be holding the digital pointing device 103. The electronic device 105 may be rendered with content in a predefined format as selected by the user. In an embodiment, the electronic device 105 may include, but is not limited to, a laptop, a desktop computer, a Personal Digital Assistant (PDA), a notebook, a smartphone, IOT devices, a tablet, a server, and any other computing devices. A person skilled in the art would understand that, any other devices, not mentioned explicitly, may also be used as the electronic device 105 in the present disclosure.

The content providing system 101 may identify and render hand written content onto a digital display interface (not shown explicitly in FIG. 1) of the electronic device 105. In an embodiment, the content providing system 101 may exchange data with other components and service providers (not shown explicitly in FIG. 1) using the communication network 109. The communication network 109 may include, but is not limited to, a direct interconnection, an e-commerce network, a Peer-to-Peer (P2P) network, Local Area Network (LAN), Wide Area Network (WAN), wireless network (for example, using Wireless Application Protocol), Internet, Wi-Fi and the like. In one embodiment, the content providing system 101 may include, but is not limited to, a laptop, a desktop computer, a Personal Digital Assistant (PDA), a notebook, a smartphone, IOT devices, a tablet, a server, and any other computing devices. A person skilled in the art would understand that, any other devices, not mentioned explicitly, may also be used as the content providing system 101 in the present disclosure.

Further, the content providing system 101 may include an I/O interface 111, a memory 113 and a processor 115. The I/O interface 111 may be configured to receive the real-time content handwritten by the user using the digital pointing device 103. The real-time content from the I/O interface 111 may be stored in the memory 113. The memory 113 may be communicatively coupled to the processor 115 of the content providing system 101. The memory 113 may also store processor instructions which may cause the processor 115 to execute the instructions for identifying and rendering hand written content onto digital display interface of an electronic device.

Considering a real-time situation, where the user writes using the digital pointing device 103. In such case, the content providing system 101 receives the real-time content handwritten by the user. As the user writes, the content providing system 101 may identify one or more digital objects from the content. The content providing system 101 may use a trained neural network model for identifying the one or more digital objects. In an embodiment, the neural network model may include a Convolutional Neural Network (CNN) technique. The neural network model may be trained previously using a plurality of handwritten content and plurality of digital objects identified manually. The content providing system 101 may identify the one or more digital objects based on coordinate vector formed between the digital pointing device 103 and a boundary formed within which the user writes along with coordinates of the boundary. For instance, the coordinate vector may be x, y and z axis coordinates. In an embodiment, the one or more digital objects may include, but not limited to, paragraphs, text, alphabets, table, graphs and figures. Further, the coordinate vector and the coordinates of the boundary are retrieved from one or more sensors attached to the digital pointing device 103.

The one or more sensors may include an accelerometer, a gyro meter and the like. In an embodiment, the one or more digital objects may be a character when the digital pointing device 103 is identified to be not lifted, a table when the digital pointing device 103 is identified to be lifted a plurality of times based on number of rows and columns in the table and as figures based on tracing of coordinates and relations. Further, the one or more digital object may be a graph based on contours or points in the boundary. The content providing system 101 converts each of the one or more digital objects to a predefined standard size. In an embodiment, the conversion to predefined standard size may be required as the user may write in three-dimensional space with different font free size. On converting to the predefined standard size, the content providing system 101 may identify one or more characters associated with the one or more digital objects. For instance, the one or more characters may be associated with the text, or text in the table, figure, graph and the like. The one or more characters may be identified based on a plurality ofpredefined character pair and corresponding coordinates using a Long Short-Term Memory (LS™) neural network model. In an embodiment, the content providing system 101 may generate a user specific contour based on handwritten content previously provided by the user. The user specific contour may be stored in the database 107.

The user specific contour may include the predefined character pair. Further, the content providing system 101 may determine a dimension space for each of the one or more digital objects based on corresponding coordinate vector. In an embodiment, each of the one or more digital objects may be converted to the determined dimension space. In an embodiment, each character in the one or more digital objects may be converted to a predefined standard size. For instance, a character length may be scaled-up or scaled down in order to ensure different size of characters to a same level. Thereafter, the content providing system 101 may render the one or more digital objects and the one or more characters handwritten by the user in a predefined standard format on the digital display interface of the electronic device 105. In an embodiment, the predefined standard format may be word format, image format, excel and the like based on choice of the user.

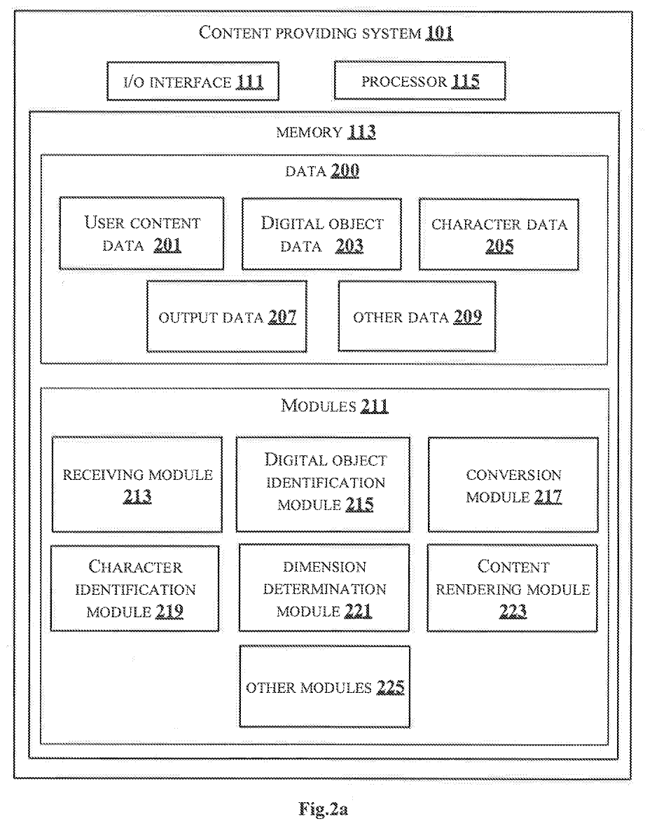

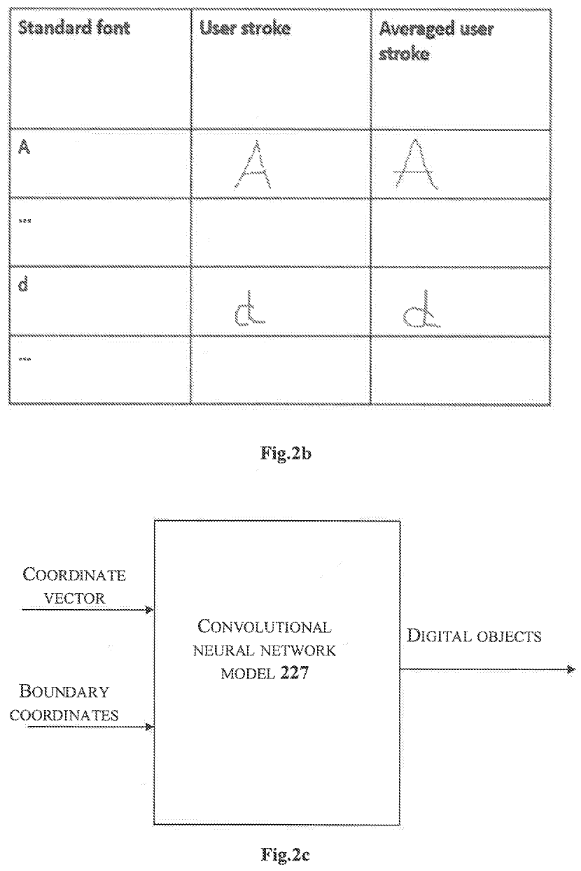

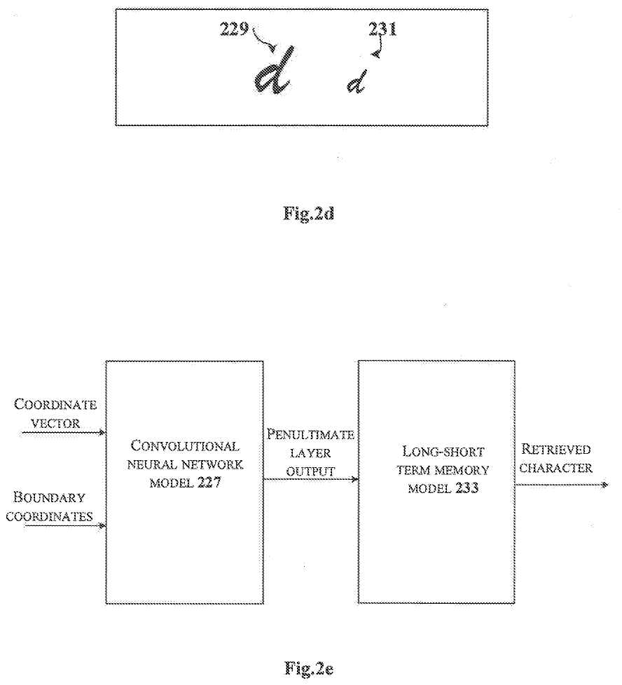

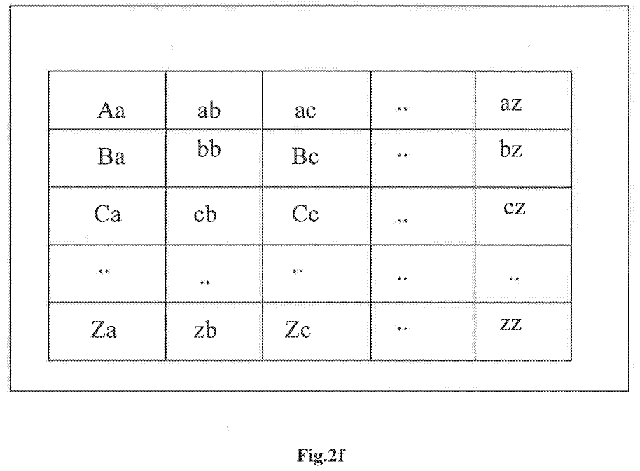

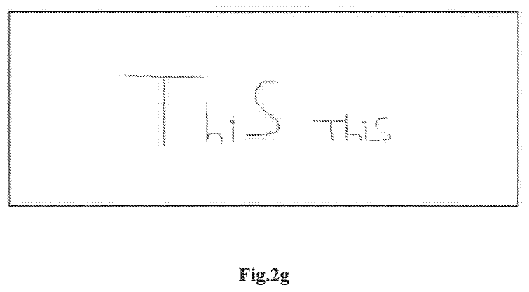

FIG. 2a shows a detailed block diagram of a content rendering system in accordance with some embodiments of the present disclosure.

The content providing system 101 may include data 200 and one or more modules 211 which are described herein in detail. In an embodiment, data 200 may be stored within the memory 113. The data 200 may include, for example, user content data 201, digital object data 203, character data 205, output data 207 and other data 209.

The user content data 201 may include the user specific contour generated based on handwritten content previously provided by the user. In an embodiment, the user specific contour may be stored in a standard contour library of alphabets. The standard contour library of alphabets may be stored in the database 107. Alternatively, user content data 201 may contain the standard contour library of alphabets. In an embodiment, the user specific contour may be generated based on a text consisting of all alphabets, cases, digits and figures such as, circle, rectangle, square and the like, tables of any number of rows and column, a figure provided by the user. FIG. 2b shows an exemplary representation of a standard contour library of alphabets. Similarly, such standard contour library may be generated for tables, digits, figures and the like. Further, the user content data 201 may include the real-time content handwritten by the user using the digital pointing device 103.

The digital object data 203 may include the one or more digital objects identified from the content handwritten by the user. The one or more digital objects may include the paragraphs, the text, the alphabets, the tables, the graphs, the figures and the like.

The character data 205 may include the one or more characters identified for each of the one or more objects identified from the content. In an embodiment, the characters may be alphabets, digits and the like.

The output data 207 may include content which may be rendered on the electronic device 105 of the user. The content may include the one or more digital objects along with the one or more characters.

The other data 209 may store data, including temporary data and temporary files, generated by modules 211 for performing the various functions of the content providing system 101.

In an embodiment, the data 200 in the memory 113 are processed by the one or more modules 211 present within the memory 113 of the content providing system 101. In an embodiment, the one or more modules 211 may be implemented as dedicated units. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. In some implementations, the one or more modules 211 may be communicatively coupled to the processor 115 for performing one or more functions of the content providing system 101. The said modules 211 when configured with the functionality defined in the present disclosure will result in a novel hardware.

In one implementation, the one or more modules 211 may include, but are not limited to a receiving module 213, a digital object identification module 215, a conversion module 217, a character identification module 219, a dimension determination module 221 and a content rendering module 223. The one or more modules 211 may also include other modules 225 to perform various miscellaneous functionalities of the content providing system 101. In an embodiment, the other modules 225 may include standard contour library generation module and a character conversion module. The standard contour library generation module may create the user specific contour to update in the standard contour library of the alphabets. Particularly, the user is requested to customize one time before by writing the text consisting of all alphabets, cases, digits and simple figures like circle, rectangle, square and circle, tables, figures and the like. The standard contour library generation module builds the user specific contour library for the user. In case the user specific contour is not is available, the standard contour library generation module may use the standard contour library.

The exemplary standard contour library of alphabets is shown in FIG. 2b. In one implementation, character strokes are decomposed for each characters. In an embodiment, average user stroke may happen due to the average stroke/character of a large number of characters obtained offline. In one embodiment, the standard contour library may contain all possible two consecutive letters. For instance, in English, it adds to “676” entries. In an embodiment, if lower case alphabets followed by upper case alphabets and consecutive upper cases are supported, it adds to “2028” entries. In an embodiment, upper case alphabets followed by lower case alphabets, such as bAt or bAT, may be omitted for simplicity. FIG. 2f shows an exemplary representation of images of two consecutive alphabets letters in accordance with embodiments of the present disclosure. A similar table may be generated for lower alphabet letters followed by capital letter. In an embodiment, based on the table, any combination of cursive letters may be recognized with using the CNN. In an embodiment, the CNN model may be pre trained with training datasets of letter combinations. Further, the character conversion module may convert each character in the one or more digital objects to the predefined standard size. In an embodiment, the character conversion module may define a rectangular boundary around a region containing the one or more characters to scale down or scale up characters to the predefined size. The character conversion module done may scale-up or scale-down the characters based on start and end coordinates of the one or more characters.

FIG. 2g shows an exemplary representation of scaling characters in accordance with some embodiments of the present disclosure. In an embodiment, the character conversion module may identify the region of interest. In an embodiment, the digital display interface of the user may be split into two halves to enable what the user is typing and what may be rendered. For instance, if the user feels that an error may be occurred typing, correction may be performed by erasing. In an embodiment, erasing may be initiated by reversing the digital pointing device 103 and rubbing virtually or with a press of a button in the digital pointing device 103. The character conversion module may place the one or more characters being typed in the region of interest of main window.

The receiving module 213 may receive the content handwritten by the user in real-time from using the digital pointing device 103. The receiving module 213 may receive the user specific contour from the digital pointing device 103. Further, the receiving module 213 may receive the one or more digital objects and the one or more characters handwritten by the user in the predefined standard format for rendering onto the digital display interface of the electronic device 105.

The digital object identification module 215 may identify the one or more digital objects from the content based on the coordinate vector formed between the digital pointing device 103 and the boundary within which the user writes along with the coordinates of the boundary. In an embodiment, the coordinate vector and the coordinates of the boundary are retrieved from the one or more sensors attached to the digital pointing device 103. The one or more sensors may include accelerometer and gyro meter. In an embodiment, the coordinate details of the x, y and z components derived from accelerometer and gyro meter may determine the coordinate vector. For instance, as soon as the user lifts the digital pointing device 103, value of “z” axis may change, in case of writing in x, y plane. In an embodiment, the one or more digital objects may include paragraphs, text, character, alphabets, table, graphs, figures and the like. In an embodiment, a way of lifting the digital pointing device 103 while writing may help in determining the one or more digital objects. For instance, the digital object identification module 215 may identify the character when the digital pointing device 103 is identified to be not lifted. For instance, for a connected letter in a word such as, ‘al’ in altitude, or for full word such as ‘all’, the digital pointing device 103 may likely be not lifted.

Further, when a word or a part of the word is written, the characters may be segregated using a moving window until a match with a character is identified. In an embodiment, the boundary of writings is marked which may increase in one direction if the user writes characters and rolls back after regular intervals of coordinates. The one or more digital objects is identified as the table when the digital pointing device 103 is identified to be lifted the plurality of times based on number of rows and columns in the table. For instance, movement of the digital pointing device 103 may be, left start and right end for rows separator and upstart, down end for column separators. In an embodiment, the one or more digital objects may be the table, if the user continuously writes in a closed boundary after a regular lift of the digital pointing device 103 in the boundary. Further, the one or more digital objects may be identified as the figures such as, circle, rectangle, triangle and the like based on tracing of coordinates and relations and as the graphs based on contours or points in the boundary.

In an embodiment, the one or more digital objects may be the figure, if the user fills up writings other than characters in a fixed region. FIG. 2c shows an exemplary Convolutional Neural Network (CNN) for segregating type of digital objects. As shown in the FIG. 2c, a CNN model 227 may segregate the one or more digital objects based on the coordinate vectors and the boundary coordinates. In an embodiment, a capsule network may be used to support 3D projections of the characters. In an embodiment, the digital object identification module 215 may absorbs line thickness or intensity of change to provide an indication of an overwriting or retrace while writing the characters. For example, while writing the character such as, ‘ch’, vertical arm of the word “h” may be retraced.

The conversion module 217 may convert the one or more digital objects to the predefined standard size. In an embodiment, the conversion may be required since the user uses fonts of free size while writing in 3D space. The conversion module 217 may scale the size of the one or more digital objects to get the standard size. In an embodiment, the scaling may be performed non-uniformly. FIG. 2d shows an exemplary representation of converting one or more digital objects to predefined standard in accordance with some embodiments of the present disclosure.

FIG. 2d shows a character as the digital object. The character “d” represented by 229 is written too long. Thus, the conversion module 217 may convert the character “d” 229 to a scaled version “d” 231 by making scaling lower part of the character “d” 229. Similarly, a broad part of the character may be converted to the predefined standard size by performing horizontal scaling. For example, in a letter “a”, if a ‘o’ part in bottom left is too small, the conversion module 217 may scale bottom part of the letter. In an embodiment, down sampling or wavelets may be used to reduce size.

The character identification module 219 may identify the one or more characters associated with the one or more digital objects based on the plurality of predefined character pair and corresponding coordinates. In an embodiment, when the one or more characters are associated with the tables, graphs or figures, the character identification module 219 may place the one or more characters at right row and the column of the tables and right position in the graphs and figures based on the coordinates. In an embodiment, when the one or more digital objects contain more than one character, the characters may be split into single characters through objection detection. In such context, the one or more characters may be objects and the coordinates of each object may be extracted from corresponding digital object to extract the character. The character identification module 219 may use a combination of CNN, for visual feature generation, and the LSTM for remembering sequence of characters in a word. FIG. 2e shows an exemplary representation for identification of characters using neural networks in accordance with some embodiments of the present disclosure.

FIG. 2e shows the combination of the CNN model 227 and an LSTM model 233. The combination of CNN model 227 and the LSTM model 233 may classify the handwritten character in to a standard font caption or class. In an embodiment, once the one or more characters are retrieved from the LSTM model 233, the character pairs may be applied to another CNN for verifying correctness of the one or more identified characters.

The dimension determination module 221 may determine the dimension space required for each of the one or more digital objects based on corresponding coordinate vector. For instance, if the one or more digital objects may be identified as the figure or the graph, the dimension determination module 221 may check the “z” coordinate variations, which indicates thickness. In an embodiment, if the thickness or the “z” coordinate is relatively small than other dimensions, the dimension determination module 221 may consider the dimension as aberration and convert the digital object to two-dimensional plane. In another embodiment, if the dimension is the three-dimensional plane, the dimension determination module 221 may transform the digital object to a mesh with corresponding coordinates. The mesh may be filled in encompassing the space curve provided by the user. In another implementation, the user written curves may be scaled to the standard size and compared with vocabulary like words. In an embodiment, the standard curves such as, a rectangle may replace the user written curves with a rectangle object present in the standard library of figures. In an embodiment, the dimension determination module 221 may fill missing coordinates for the digital objects from the standard library while scanning the three-dimensional object. Same procedures may be applied for the four-dimensional objects.

The content rendering module 223 may render the one or more digital objects and the one or more characters handwritten by the user in the predefined standard format on the digital display interface of the electronic device 105. The content rendering module 223 may render by mapping the coordinates of the one or more digital object and one or more characters to coordinates of the electronic device 105. In an embodiment, the three-dimensional objects may be observed on the digital display with hep of a three-dimensional glass. In an embodiment, the one or more digital objects and the one or more characters is time controlled to achieve a realistic video effect.

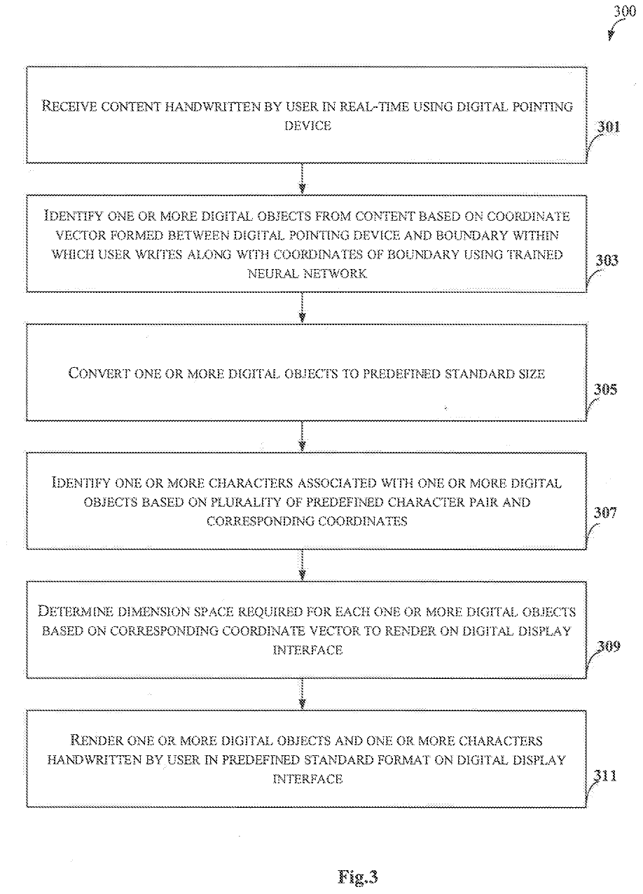

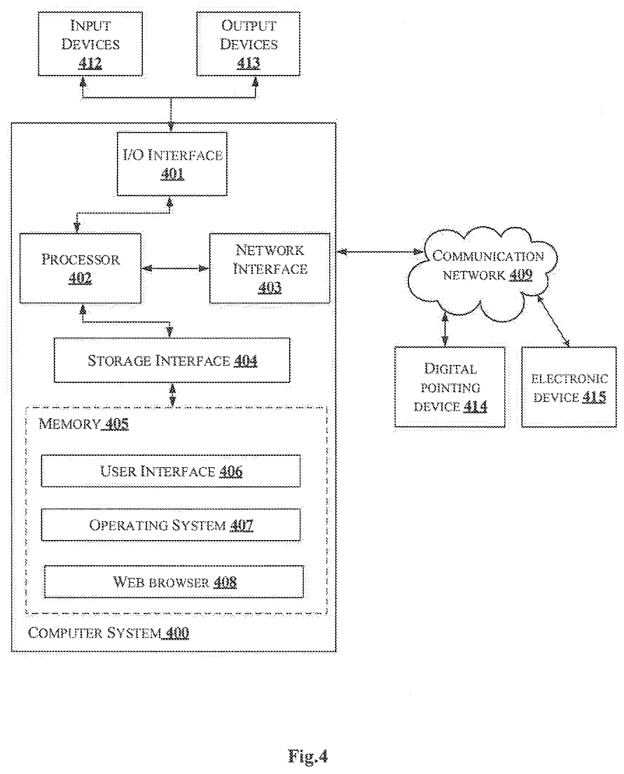

FIG. 3 illustrates a flowchart showing a method for identifying and rendering hand written content onto digital display interface of an electronic device in accordance with some embodiments of present disclosure.

As illustrated in FIG. 3, the method 300 includes one or more blocks for identifying and rendering hand written content onto digital display interface of an electronic device. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the content handwritten by the user is received by the receiving module 213 in real-time using the digital pointing device 103.

At block 303, the one or more digital objects may be identified by the digital object identification module 215 from the content based on the coordinate vector formed between the digital pointing device 103 and the boundary within which the user writes along with coordinates of the boundary. In an embodiment, the digital object identification module 215 may use the trained neural network model for identifying the one or more digital objects.

At block 305, the one or more digital objects may be converted by the conversion module 217 to the predefined standard size.

At block 307, the one or more characters associated with the one or more digital objects may be identified by the character identification module 219 based on the plurality of predefined character pair and corresponding coordinates.

At block 309, the dimension space required for each of the one or more digital objects is determined by the dimension determination module 221 based on the corresponding coordinate vector. In an embodiment, each of the one or more digital objects are converted to the determined dimension space.

At block 311, the one or more digital objects and the one or more characters handwritten by the user may be rendered by the content rendering module 223 in the predefined standard format on the digital display interface.

FIG. 4 illustrates a block diagram of an exemplary computer system 400 for implementing embodiments consistent with the present disclosure. In an embodiment, the computer system 400 may be used to implement the content providing system 101. The computer system 400 may include a central processing unit (“CPU” or “processor”) 402. The processor 402 may include at least one data processor for identifying and rendering hand written content onto digital display interface of an electronic device. The processor 402 may include specialized processing units such as, integrated system (bus) controllers, memory management control units, floating point units, graphics processing units, digital signal processing units, etc.

The processor 402 may be disposed in communication with one or more input/output (I/O) devices (not shown) via I/O interface 401. The I/O interface 401 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the computer system 400 may communicate with one or more I/O devices such as input devices 412 and output devices 413. For example, the input devices 412 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 413 may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

In some embodiments, the computer system 400 consists of the content providing system 101. The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 409 may include, without limitation, a direct interconnection, local area network (LAN), wide area network (WAN), wireless network (e.g., using Wireless Application Protocol), the Internet, etc. Using the network interface 403 and the communication network 409, the computer system 400 may communicate with a digital pointing device 414 and an electronic device 415. The network interface 403 may employ connection protocols include, but not limited to, direct connect, Ethernet (e.g., twisted pair 10/100/1000 Base T), transmission control protocol/internet protocol (TCP/IP), token ring, IEEE 802.11 a/b/g/n/x, etc.

The communication network 409 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407 etc. In some embodiments, computer system 400 may store user/application data, such as, the data, variables, records, etc., as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 400 may implement a web browser 408 stored program component. The web browser 408 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 708 may utilize facilities such as AJAX™, DHTML™, ADOBE® FLASH™, JAVASCRIPT™, JAVA™, Application Programming Interfaces (APIs), etc. In some embodiments, the computer system 400 may implement a mail server stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure helps user in rendering hand written text to a machine readable specific format.

An embodiment of the present disclosure may be robust to take a 3D curve generated while writing the text. It can fill up for discontinuities in trajectory.

An embodiment of the present disclosure can differential between figures, tables, characters and graphs written/gestured by the user.

An embodiment of the present disclosure may scan simple 3D objects, 4D objects.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further include a wireless signal, satellite transmission, radio waves, infrared signals, Bluetooth, etc.

The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

REFERRAL NUMERALS:

| Reference number | Description |
|---|---|
| 100 | Environment |
| 101 | Content providing system |
| 103 | Digital pointing device |
| 105 | Electronic device |
| 107 | Database |
| 109 | Communication network |
| 111 | I/O interface |
| 113 | Memory |
| 115 | Processor |
| 200 | Data |
| 201 | User content data |
| 203 | Digital object data |
| 205 | Character data |
| 207 | Output data |
| 209 | Other data |
| 211 | Modules |
| 213 | Receiving module |
| 215 | Digital object identification module |
| 217 | Conversion module |
| 219 | Character identification module |
| 221 | Dimension determination module |
| 223 | Content rendering module |
| 225 | Other modules |
| 227 | Other modules |
| 229 | Person |
| 231 | Bouquet |
| 233 | Gun |
| 400 | Computer system |
| 401 | I/O interface |
| 402 | Processor |
| 403 | Network interface |
| 404 | Storage interface |
| 405 | Memory |
| 406 | User interface |
| 407 | Operating system |
| 408 | Web browser |
| 409 | Communication network |
| 412 | Input devices |
| 413 | Output devices |
| 414 | Digital pointing device |
| 415 | Electronic device |

1. A method of identifying and rendering hand written content onto digital display interface of an electronic device, the method comprising:
receiving, by a content providing system, content handwritten by a user in real-time using a digital pointing device;
identifying, by the content providing system, one or more digital objects from the content based on coordinate vector formed between the digital pointing device and a boundary within which the user writes along with coordinates of the boundary using a trained neural network, wherein the coordinate vector provides multi-dimensional coordinate details of the content handwritten or gestured by the user, and wherein the coordinate vector and the coordinates of the boundary are retrieved from one or more sensors attached to the digital pointing device;
converting, by the content providing system, the one or more digital objects to a predefined standard size;
identifying, by the content providing system, one or more characters associated with the one or more digital objects based on a plurality of predefined character pair and corresponding coordinates;
determining, by the content providing system, a dimension space required for each of the one or more digital objects based on corresponding coordinate vector to render on the digital display interface, wherein each of the one or more digital objects are converted to the determined dimension space; and
rendering, by the content providing system, the one or more digital objects and the one or more characters handwritten by the user in a predefined standard format on the digital display interface.

2. The method as claimed in claim 1, wherein the one or more digital objects comprises paragraphs, text, alphabets, table, graphs and figures.

3. (canceled)

4. The method as claimed in claim 1, wherein identifying the one or more digital objects comprises:
identifying, the one or more digital object as character when the digital pointing device is identified to be not lifted;
identifying, the one or more digital object as a table when the digital pointing device is identified to be lifted a plurality of times based on number of rows and columns in the table;
identifying the one or more digital object as figures based on tracing of coordinates and relations; and
identifying the one or more digital object as a graph based on contours or points in the boundary.

5. The method as claimed in claim 1 further comprising generating a user specific contour, stored in a database, based on handwritten content previously provided by the user.

6. The method as claimed in claim 1 further comprising converting each character in the one or more digital objects to a predefined standard size.

7. The method as claimed in claim 1 further comprising providing visual interactive feedback to the user while writing in order to check correctness of the content being provided in the predefined standard format.

8. A content providing system for identifying and rendering hand written content onto digital display interface of an electronic device, comprising:
a processor; and
a memory communicatively coupled to the processor, wherein the memory stores processor instructions, which, on execution, causes the processor to:
receive content handwritten by a user in real-time using a digital pointing device;
identify one or more digital objects from the content based on coordinate vector formed between the digital pointing device and a boundary within which the user writes along with coordinates of the boundary using a trained neural network, wherein the coordinate vector provides multi-dimensional coordinate details of the content handwritten or gestured by the user, and wherein the coordinate vector and the coordinates of the boundary are retrieved from one or more sensors attached to the digital pointing device;
convert the one or more digital objects to a predefined standard size;
identify one or more characters associated with the one or more digital objects based on a plurality of predefined character pair and corresponding coordinates;
determine a dimension space required for each of the one or more digital objects based on corresponding coordinate vector to render on the digital display interface, wherein each of the one or more digital objects are converted to the determined dimension space; and
render the one or more digital objects and the one or more characters handwritten by the user in a predefined standard format on the digital display interface.

9. The content providing system as claimed in claim 8, wherein the one or more digital objects comprises paragraphs, text, alphabets, table, graphs and figures.

10. (canceled)

11. The content providing system as claimed in claim 8, wherein the processor identifies the one or more digital objects by:
identifying the one or more digital object as character when the digital pointing device is identified to be not lifted;
identifying the one or more digital object as a table when the digital pointing device is identified to be lifted a plurality of times based on number of rows and columns in the table;
identifying the one or more digital object as figures based on tracing of coordinates and relations; and
identifying the one or more digital object as a graph based on contours or points in the boundary.

12. The content providing system as claimed in claim 8, wherein the processor generates a user specific contour, stored in a database, based on user handwritten content previously provided by the user.

13. The content providing system as claimed in claim 8, wherein the processor converts each character in the one or more digital objects to a predefined standard size.

14. The content providing system as claimed in claim 8, wherein the processor provides visual interactive feedback to the user while writing in order to check correctness of the content being provided in the predefined standard format.

15. A non-transitory computer readable medium including instruction stored thereon that when processed by at least one processor cause a content providing system to perform operation comprising:
receiving content handwritten by a user in real-time using a digital pointing device;
identifying one or more digital objects from the content based on coordinate vector formed between the digital pointing device and a boundary within which the user writes along with coordinates of the boundary using a trained neural network, wherein the coordinate vector provides multi-dimensional coordinate details of the content handwritten or gestured by the user, and wherein the coordinate vector and the coordinates of the boundary are retrieved from one or more sensors attached to the digital pointing device;
converting the one or more digital objects to a predefined standard size;
identifying one or more characters associated with the one or more digital objects based on a plurality of predefined character pair and corresponding coordinates;
determining a dimension space required for each of the one or more digital objects based on corresponding coordinate vector to render on the digital display interface, wherein each of the one or more digital objects are converted to the determined dimension space; and
rendering the one or more digital objects and the one or more characters handwritten by the user in a predefined standard format on the digital display interface.

16. The method as claimed in claim 1, wherein identifying the one or more digital objects further comprises segregating the one or more digital objects based on the coordinate vectors and the boundary coordinates using the trained neural network.
